(19) United States
(12) Patent Application Publication
(10) Pub. No.: US 2004/0238319 A1
(43) Pub. Date: Dec. 2, 2004

(54) Data communication apparatus for currency acceptor

(76) Inventors: Peter E. Hand, Las Vegas, NV (US); Russell A. Wige, Las Vegas, NV (US)

Correspondence Address: Squire, Sanders & Dempsey L.L.P., 14th Floor, 801 S. Figueroa Street, Los Angeles, CA, 90017-5554, US

(21) Appl. No.: 10/449,327

(22) Filed: May 30, 2003

(51) Int. Cl. G07F 7/04; G06K 7/00; G07D 7/00; G06K 9/00

(52) U.S. Cl. 194/207

(57) ABSTRACT

This invention provides an enhanced bezel for use with a bill acceptor. The enhanced bezel includes a processor to monitor detailed information about the status of the bill acceptor, and other information related to its operation. The processor displays this information through multiple indicators on the enhanced bezel. The bezel is also configured to include an external communication portal/interface, such as an infrared data communications (“IrDA”) interface, to output information to an external personal digital assistant (“PDA”) or portable computer device. The external device may be capable of downloading data, and, if appropriate, it may reprogram the bill acceptor, calibrate sensors in the bill acceptor, and perform hardware tests, among other tasks. The bill validator's external communication portal/interface will communicate with the external device through a secure proprietary interface protocol.

### BACKGROUND OF THE INVENTION

1. Field of the Invention

The present invention relates to a communication system intended for use with a currency or bill acceptor which is to be incorporated into an electronic gaming machine, vending machine, point of sale devices or similar type of host machines.

2. General Background and State of the Art

Bill acceptors are now in widespread use in host machines such as gaming machines, vending machines and point of sale devices. Bill acceptors receive paper currency or notes and, using a validator having both hardware and software components, the received currency or note is scanned with a variety of sensors. The sensor information is analyzed to determine authenticity and denomination of the currency or note. If the note is determined to be authentic, e.g. a United States $1, $5, $10, $20, $50 or $100 bill or other legal tender, the note is transported to a cash box within the bill acceptor for storage. Further, based upon the denomination of the accepted currency or note, a signal is sent from the validator to the host machine's controller or processor to cause the host machine to credit or accumulate a corresponding amount within the machine's credit meter representing the cash value available for purchasing products or wagering. Bill acceptors of this type are known and are discussed for example in U.S. Pat. No. 5,863,039 issued Jan. 26, 1999 to Suzuki.

The rising use of bill acceptors while potentially reducing the number of attendants, has given rise to several problems associated with their incorporation in a host machine. Some users believe that they have inserted a bill having a higher value than what the machine provides as credits. For example, the user may believe that he or she has inserted a twenty dollar bill while the machine only provides ten dollars in credit. This problem generally requires the attention of an attendant who may be required to open the machine to show the user the last bill inserted to resolve the dispute.

In addition, bill acceptors may reject notes for a variety of reasons irrespective of the fact that the notes are valid. For example, bill acceptors may reject valid notes that are worn, folded, soiled, washed or otherwise damaged. Similarly, bill acceptors may place a gaming machine in an “out of service” mode for a number of reasons, including having a full cash box, jammed bill transport path and sensor malfunction. Under present systems, these types of problems may not be reported to the casino, causing customer dissatisfaction and potentially lost revenue. In these circumstances, when the casino is ultimately notified or becomes aware of the problem the attendant may have to place the machine into a “diagnostic mode” to allow extraction of information from the note acceptor to determine the cause of the problem. These types of activities are both labor intensive and inefficient as the machine is taken out of operation until the issue is resolved.

In most host machines, including gaming machine applications, the bill acceptor assembly is predominantly hidden within the host machine, only a small portion of the bill acceptor, a protruding section featuring a rectangular slot where the note or currency is to be inserted, is visible to users. The location of the rectangular slot may be readily identified by a bezel which, in the context of gaming machines, vending machines or the like, is a structure projecting from the front portion of the bill acceptor below the intake slot. The use of bezels in the gaming machine industry has been limited to providing passive functions. For example, it is known to have bezels with several light emitting devices (LEDs) arranged to flash in a runway sequence to attract the patron's attention and identify where the note is to be inserted. It is also known that bezels with different color LEDs, i.e. green and red, are available to provide an indication of whether the bill acceptor is operational. The status information available from these bezels is, however, very limited, i.e. whether the bill acceptor of the machine is enabled or disabled, and present devices do not provide any other functional utility or diagnostic information.

### INVENTION SUMMARY

The present invention is generally directed to a note or bill acceptor, and-more particularly, to a communication system which features an interface which may be incorporated into an enhanced bezel positioned at or near the intake slot of the bill acceptor. The enhanced bezel is adapted to display detailed information about the status of the bill acceptor and to communicate other information related to its operation.

The enhanced bezel of the present invention employs multiple indicators to visually display information. For example, the enhanced bezel may include indicators to display error conditions such as “note box full” or “transport path jammed” conditions, and other information useful for maintenance and diagnostic purposes. Additional visual indicators may display set up information, such as which denominations the bill validator of the machine is programmed to accept, display prompts or instructions to assist the player, such as a display of the denomination of the last bill accepted, or even simple decorative patterns.

More specifically, the enhanced bezel may include a display area to provide a visual display of information about the bills, vouchers, script and/or currency (hereinafter, collectively “notes”) accepted by the bill acceptor. For example, the display may have a visual depiction or back-lighted display to show if the received bill has a $1, $5, $10, $20, $50 or $100 denomination. The display is connected to the bill acceptor's processor which receives information from the note validator which senses the authenticity, denomination, amount and type of the note passing through the bill acceptor and which issues a signal corresponding to the note type to the bill acceptor processor and the host machine's processor for accumulation of credits. The same information can be used to control the display on the enhanced bezel.

Further, the bill acceptor will include a note box provided to receive deposited notes and a transport assembly for transporting notes accepted through the note validator to the note box. The bill acceptor-validator processor controls the transport assembly to direct notes received through the note validator to the note box and detects any interference with the operation of the bill acceptor. The bill acceptor's processor also keeps track of the number of bills sent to the note box for retention. Thus, by connecting the processor to the enhanced bezel, additional status information, such as a jammed transport path or full note box may be visually displayed by the enhanced bezel.

The bezel is also configured to include an external communication portal/interface, such as an infrared data communications (“IrDA”) interface, to output information to an external personal digital assistant (“PDA”) or portable computer device. The external device may be capable of downloading data, and, if appropriate, it may reprogram the bill acceptor, calibrate sensors in the bill acceptor, and perform hardware tests, among other tasks. The bill validator's external communication portal/interface will communicate with the external device through a secure proprietary interface protocol.

The combination according to the present invention offers many benefits to the owner or operator of the gaming or vending machines which may be beneficial to the service technicians. The present invention will enable a service technician to communicate with and extract information from the bill acceptor without opening the machine or removing the bill acceptor. As the communication is done through a wireless interconnection, a service technician, using a handheld PDA type device, could walk up to a slot machine and non-intrusively inquire about the status and history of the bill acceptor. With a few keystrokes, the service technician can discreetly extract information from and transmit pertinent information to the bill acceptor. This way, the present invention would decrease the interference involved in servicing the machine, would increase revenues based on early detection of problems, and would decrease the cost of extracting information from a particular machine, as less time is required.

The enhanced bezel display system of the present invention thus provides an easy method of interacting with the user of the machine to provide a verification of the denomination of received notes. The enhanced bezel of the present invention also enables the attendant of the machine to quickly retrieve information regarding various operations, including the status of the bill acceptor, without having to interrupt the use of the machine.

### BRIEF DESCRIPTION OF THE DRAWINGS

FIG. 1 shows a gaming machine including the bill acceptor having an enhanced bezel according to the present invention;

FIG. 2 shows a perspective view of a bill acceptor having the enhanced bezel according to the present invention;

FIG. 3 shows a detailed front view of one version of the enhanced bezel according to the present invention; and

FIG. 4 is a block diagram of the electronic components of a communication system according to the present invention.

### DETAILED DESCRIPTION OF THE PREFERRED EMBODIMENTS

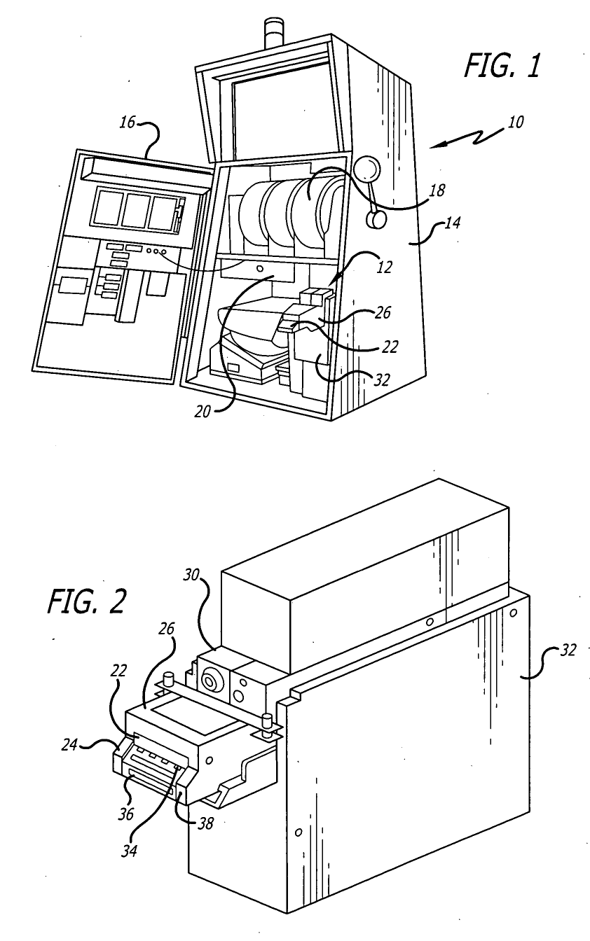

The present invention can be used in gaming machines, vending machines and pay point machines, where currency or bills are accepted for credits. For purposes of detailing the invention, however, the description herein as shown in FIG. 1, is tailored to the application of the invention in a gaming machine 10. The gaming machine 10 includes a bill acceptor 12 having an enhanced bezel according to the present invention.

The gaming machine 10 generally includes a housing 14 of various potential configurations designed to contain the various components of such machines. The interior of the gaming machine 10 may normally be accessed through opening a front cover or door 16. Disposed within the housing 14 are the reels 18 for the play of the game, a central processing unit (CPU) 20 which controls the operation of the gaming machine 10, as well as a coin hopper assembly adapted to receive, hold and dispense coins or tokens in a known fashion. As is known in the industry, the CPU 20 controls the operation of the gaming machine 10. The CPU 20 controls the selection of the outcome, monitors the amount wagered for each play or “hand,” determines winning payouts to the player, monitors the accumulation of credits at the gaming machine available for play and the like. These features, which are controlled by the CPU 20, are now well-known in the art. To monitor the performance and operation, the CPU 20 of each gaming machine 10 in a facility may be in communication with a centralized system server (not shown). The system server monitors the revenue or amounts wagered, amounts paid out and the like for each gaming machine 10 in the facility.

To play a gaming machine 10, a player inserts tokens, coins, bills, currency or script, which are sensed and, if valid, are accumulated as credits for gaming. The received coins or tokens are directed to the coin hopper assembly for storage or the coins/tokens may be directed to an auxiliary collection location, for example under the machine. Alternatively, to amass credits for play of the gaming machine 10, the gaming machine 10 is provided with the bill acceptor 12 having a validator which receives notes as legal tender or script and, based upon the note's value, assigns a corresponding value of credits within the gaming machine 10 for gaming.

The bill acceptor 12, as shown in FIG. 2, includes a validator 26 adapted to scan a note inserted into a rectangular slot or opening 22 to determine the authenticity, type (legal tender or script, if required), denomination and condition (whether the note is worn) of the note. The enhanced bezel 24 is preferably placed on the front of the bill acceptor 12 and below the opening 22. The enhanced bezel 24 is used as a mechanical interface to the game machine door 16, as it projects to or through an opening in the door 16. The enhanced bezel 24 provides a runway surface 34 immediately before the opening 22 to allow the patron to easily insert the bill into the bill acceptor 12. The enhanced bezel 24 may also include a display surface 36 vertically mounted at the leading edge of the runway surface 34. The enhanced bezel 24 also provides an ideal location for an infrared data IrDA transceiver 38 which will not be obstructed by the door 16 of the gaming machine.

A bill, once inserted over the runway surface 34 and into opening 22, is captured and transported by a transportation unit 30 past optical and magnetic sensors (not shown) which may, for example, sense light reflected by and/or transmitted through the note, reflectivity and transmission patterns, size of the note and the magnetic characteristics of the inserted note. The various sensors output sensed data output signals which are compared by a validator processor (not shown) to stored data representative of the range of sensor readings corresponding to authentic notes and determine the denomination.

If the note is determined to be valid and authentic, based on the comparison with the stored data for authentic notes, the transportation unit 30 transports the note to the note box 32 for storage. Also, upon receipt and determination of validity, a signal is sent to the gaming machine's CPU 20 signifying receipt as well as the denomination of the note for accumulation of a like value amount of credits in the gaming machine 10.

If the note is not validated, the transportation unit 30 is reversed and the note is ejected through the opening 28 to the customer. A note could be rejected even if it is valid if it is worn, folded, torn, dirty or contaminated for example by having been run through a washing machine cycle. Also, if a sensor in the bill acceptor 12 is damaged or dirty, the bill acceptor 12 may reject all notes. For any of these reasons why a note is rejected, the bill acceptor 12 may store a particular rejected note data log in the validator processor for access by a technician.

The information on validated notes accumulated by the validator processor, such as the status of the bill acceptor and denomination of accepted notes, is available to be communicated to and displayed on the indicators on the runway surface 34 and/or display surface 36 of the enhanced bezel 24. The information may also be communicated by the infrared data (IrDA) transceiver 38.

The display indicators on the enhanced bezel 24 may be controlled directly by the validator processor, or the enhanced bezel may have its own logic device such as a bezel processor (not shown). The bezel processor may be configured and connected to monitor the communications between the bill validator and the host, or it may receive special signals from the validator processor. The bezel processor may also communicate directly with the validator processor using a secondary interface. The bezel processor determines the state of the validator and/or the host machine, and uses the results to control the visual display indicators.

The bezel processor may monitor the status and activity information provided by the validator processor, and use the results to control the indicators. The bezel processor may alternatively be placed on the controller of the bill acceptor 12.

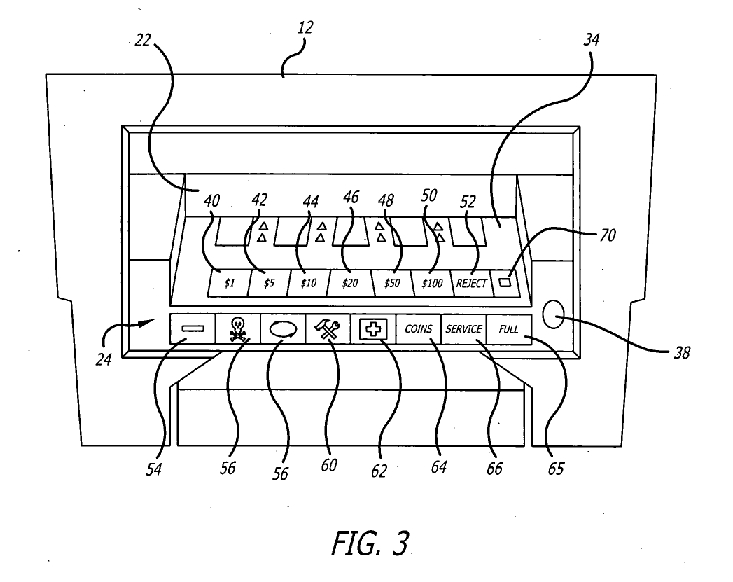

As shown in FIG. 3, the enhanced bezel 24 has multiple display indicators on the runway surface 34, including a $1 indicator 40, $5 indicator 42, $10 indicator 44, $20 indicator 46, $50 indicator 48 and $100 indicator 50 which display the denomination of received and accepted notes. The runway surface 34 may also include a coupon indicator 70 to indicate whether the coupon has been accepted or not. In addition, the runway surface may have a “reject” indicator 52, to visually display when an unacceptable bill has been inserted and rejected. Additional indicators located on the display surface 36 of the enhanced bezel, in addition to the infrared data transmitter 38, may include a system lock indicator 54, counterfeit bill indicator.56, transport jam indicator 58 and service indicator 60. The display surface 36 may also include additional indicators for the host machine, such as a diagnostic indicator 62, coin indicator 64, machine service indicator 66 and validator note box full indicator 68. It should be understood that the various specific display indicators described herein are representative only, and other types of display symbols may be substituted.

For all of the various indicators there are several different methods of displaying the information, for example by back side illumination using, alone or in combination, incandescent lamps, LEDs, electroluminescent emitters, liquid crystals, numeric alphanumeric and graphic displays, and mechanical semaphores. The various indicators are preferably an integral part of a molded or fabricated bill entry piece 34 of the bill acceptor 12. Alternatively, the indicators may be separate from the bill acceptor or be part of an associated display panel placed on a display surface of the host machine.

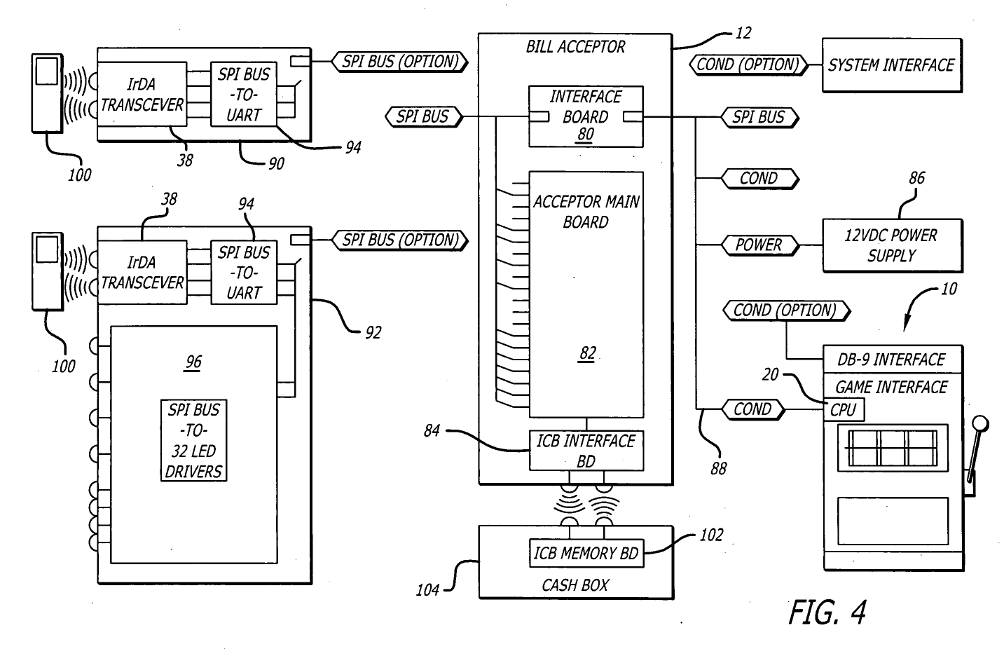

Further, the infrared data transmitter 38 providing the diagnostic and machine service data are preferably wireless data communication output devices capable of communicating with a PDA or portable computer as illustrated in the block diagram of FIG. 4. As illustrated in FIG. 4, the control electronics of the bill acceptor 12 may include an interface board 80 and an acceptor main board 82 having the validator processor and a cash box interface board 84. Alternatively, the interface board 80 may be located on a separate circuit board located between the main board 82 and the boards 90 and 92. Both the interface board 80 and cash box interface board 84 are electrically connected to the main board 82 of the bill acceptor 12. Alternatively, the interface board 80 may be mounted on a separate circuit board to reduce the size of the circuit board that the main board 82 is mounted. For instance, the interface board 80 may be located between the main board 82 and the boards 90 and 92. In addition, the interface board 80 may be connected to a power supply 86 within the gaming machine 10 as well as through a COM link 88 to the CPU 20 of the gaming machine 10. The power from the power supply 86 may be provided to the main board 82 directly through a wiring connected directly between the power supply 86 and the main board 82. As illustrated in FIG. 4, the wiring connection from the power supply 86 may also connect through the interface board 80 and then to the main board for an indirect or passive connection. The interface board 80 may also have an interconnect electrical output to interconnect to either an IrDA interface board 90 or to a bezel processor/IrDA board 92.

If the IrDA interface board 90 is used, the information provided by the interface board 80 of the bill acceptor connects to a synchronous peripheral interface (SPI) bus and/or serial interface or transceiver controller 96 which is in electrical communication with an IrDA transceiver 38, or other types of communication interfaces. The IrDA circuit boards 90 and 92 may communicate passively between the interface board 80 and the corresponding IrDA transceivers 38. The IrDA transceiver 38 can communicate via infrared data communication with a PDA or portable computer 100. Similarly, if the bezel processor/IrDA board 92 is incorporated into the system, the information provided by the interface board 80 of the bill acceptor 12 may be directed to an SPI bus and/or serial interface or transceiver controller 94 which is in data communication with an IrDA transceiver 38 which communicates to a PDA or portable computer 100. The transceiver controller 94 in the IrDA interface boards 90 and 92 may each have a Universal Asynchronous Receiver-Transmitter (UART) to buffer the received and transmitted data, and may add and remove the IrDA communication protocol and adjust the pulse timing for the IrDA transceiver 38. In addition, the bezel processor/IrDA board 92 includes a controller 96 to drive a series of LED drivers, for example, on the front face of the bezel.

As noted above, the bill acceptor 12 may include a cash box interface board 84, which provides an optical coupling to a cash box memory board 102 within the cash box 104. Since the cash box can be removed from the gaming machine to be replaced with a different cash box or emptied and subsequently returned, in order to avoid having repeated mechanical or electrical contacts being connected and disconnected, it is preferable to use an optical data communication protocol between the cash box interface board 84 and the cash box memory board 102. By this configuration, the bill acceptor may obtain data from and write data to the cash box. For example, when a cash box which includes a note recycling system is inserted into the gaming machine, it may include a stack of preselected bills. The information concerning the number and denomination of these bills may need to be downloaded from the cash box's cash box memory board to the cash box interface board 84 of the bill acceptor controller. From there, the information is provided to the bill acceptor's main CPU so that the main CPU keeps track of the amount of cash within the cash box. In addition, the cash box memory board may log information regarding the accepted notes, coupons, and acceptor errors. The cash box memory may also provide a method to link the cashbox number to a specific game for a given drop.

The bill acceptor according to the present invention includes a number of internal meters that record detailed information on the acceptance and performance for each denomination of both new and old style bills and the inserted direction of the bill. The bill acceptor may have a number of meters to determine why a bill would be rejected and other meters to record hardware error conditions. For instance, there may be fifteen meters to determine the reasons for rejecting the bill and another fifteen meters to record the hardware error conditions. To extract the performance and information from meters historically requires removal of the acceptor, setting the dip switches and connecting the controller to a PC running a proprietary program. The new IrDA interface protocol allows the bill acceptor to be interrogated without opening the front door of the gaming machine or even stopping play of the gaming machine. The IrDa interface can provide, among other things: a real-time status of events; historical meters for notes and coupons accepted, error messages for notes/coupons that were rejected; mechanical errors and failures; the bill acceptor firmware upgrade; view and modify the bill acceptor configuration; and perform hardware tests.

Using a PDA or portable computer 100, the device will have the ability to communicate with the bill acceptor using either a serial connection with the gaming machine's door open or through an IrDA interface with the gaming machine's door closed. The communication protocol may be provided by PTI (Pyramid Technologies, Inc.) Apex 5000 Tools for Palm™. Either method may utilize the subset of the functionality of the Maintenance Suite™ for security purposes.

Using the PDA or other portable computer, the service technician could walk up to a gaming machine and inquire about the acceptor status, i.e., if the note cassette is full, bill or note jams, etc., determine the last predetermined number of bills or coupons accepted, access the current software version loaded onto the bill acceptor, and check bill acceptor performance and error meters. The acceptor performance data and error meters may be saved on a portable PC device so that the collected data may be quickly analyzed and/or synchronized with a PC version of the Maintenance Suite™. If, based on the collected data, it is determined that the bill acceptor requires servicing, the portable PC device or PDA, or the like, may display the acceptance rate and a passed or failed message on the PDA. The acceptance rate calculation may be performed on the PDA. If the slot machine needs service, then it may be added to the service call checklist on the PDA, for example.

Using the portable PC in serial mode, the technician could perform all the IrDA functions as well as being able to reprogram the bill acceptor's flash memory, change configuration settings, i.e., enable, disable security level for each bill denomination, store the slot machine's asset number into the acceptor's non-volatile memory, calibrate the acceptor's sensors, and perform hardware function tests.

While the foregoing description and attached Figures define an embodiment of the present invention, it is to be understood that it is subject to many modifications and changes without departing from the spirit and scope of the appended claims.

What is claimed is:

1. A system facilitating communication between a bill acceptor and a portable device, comprising:
a bill acceptor capable of receiving a note and authenticating the note to determine whether to accept or reject the note;
a validator processor monitoring the bill acceptor and storing information concerning accepted and rejected notes; and
a wireless transceiver capable of facilitating communication between the bill acceptor and a portable device so that the validator processor can share information with the portable device.

2. The system according to claim 1, further comprising:
a cash box to receive notes from said bill acceptor; and
a wireless communication device allowing communication between the validator processor of the bill acceptor and the cash box that stores the notes.

3. The system according to claim 2, wherein the validator processor monitors the number of notes stored in the cash box.

4. The system according to claim 1, wherein said bill acceptor further comprises:
a bill acceptor interface board; and
a data bus coupling the bill acceptor interface board to the wireless transceiver.

5. The system according to claim 1, wherein the wireless transceiver further comprises:
light emitting diode drivers to control a light emitting diode indicators on the bill acceptor.

6. The system according to claim 4, wherein the system further comprises:
a bezel positioned on the bill acceptor at a location below the point of insertion of a note into the bill acceptor, the wireless transceiver being mounted on the bezel.

7. A bill acceptor, comprising:
a validator;
a transport assembly to transport bills through said validator;
a processor to control the status and activity of said validator, said processor being connected to and controlling said transport assembly; and
an infrared data transceiver coupled to said processor for providing infrared data communication signals to a remote device.

8. The bill acceptor of claim 7 wherein said processor stores information concerning one or more bill acceptor status indicators selected from the group consisting of: note cassette full, notes in note cassette, note rejection rates, note acceptance rates, note jammed signals, sensor error signals and a service regained signal.

9. The bill acceptor of claim 7, wherein said infrared data transceiver communicates data using a secure interface protocol.

10. The bill acceptor of claim 7, wherein said infrared data communication transceiver communicates data including at least one of a system lock signal, a counterfeit bill signal, a transport jam signal and a service required signal.

11. The bill acceptor of claim 7, wherein said infrared data communication transceiver communicates data including at least one of a diagnostic indicator, a coin indicator, a bill acceptor service indicator and a note box full indicator.

12. The bill acceptor of claim 7, further including:
a cash box to receive notes from said bill acceptor; and
a communication device that allows communication between the processor and the cash box.

13. The bill acceptor of claim 12, wherein the communication device is a wireless.

14. The bill acceptor of claim 7, wherein said infrared data communication transceiver communicates data includes a real time status of said validator and transport assembly.

15. The bill acceptor of claim 12, wherein said infrared data communication transceiver communicates data includes a real time status of said cash box.

16. The bill acceptor of claim 7, wherein said infrared data communication transceiver communicates data including at least one of historical meters of notes and coupons accepted, error codes for rejecting notes and coupons, error codes for mechanical failures of said bill acceptor, said bill acceptor firmware upgrade information, view and modify said bill acceptor configuration information, and status of mechanical hardware test of said bill acceptor.

17. The bill acceptor of claim 7, further comprising:
a bezel positioned at the beginning of the transport assembly, the bezel having a runway surface and a display surface vertically mounted with respect to said runway surface; and
an infrared data transceiver mounted on the bezel.

18. A system for communicating between a bill acceptor and a portable data organizing device, comprising:
means for receiving and transporting a note;
validator means for authenticating received notes to determine whether the notes are authentic;
controller means for controlling the means for receiving and the validator means;
the controller means having a memory for storing information about authenticated notes; and
contactless data communication means for communicating information from the memory of the controller means to the portable data organizing device.

19. The system according to claim 18, where the portable data organizing device is a personal digital assistant.

20. The system according to claim 18, where the portable data organizing device is a portable computer.
